(19) United States
(12) Patent Application Publication
(10) Pub. No.: US 2011/0064391 A1
(43) Pub. Date: Mar. 17, 2011

(54) VIDEO-AUDIO PLAYBACK APPARATUS

(75) Inventor: Koji HISAMOTO, Kanagawa-ken (JP)

(73) Assignee: KABUSHIKI KAISHA TOSHIBA, Tokyo (JP)

(21) Appl. No.: 12/883,038

(22) Filed: Sep. 15, 2010

(30) Foreign Application Priority Data
Sep. 16, 2009 (JP) 2009-213990

(51) Int. Cl. H04N 5/93

(52) U.S. Cl. 386/354; 386/E05.003

(57) ABSTRACT

According to one embodiment, a video-audio playback apparatus includes: a compressed-audio-data decoding portion configured to decode compressed audio data of a program and thereby to generate audio data; an audio data processing portion configured to compare a sound volume of the audio data for an arbitrarily-determined period with a threshold; and a compressed-video-data decoding portion configured to perform first decoding processing on compressed video data for the arbitrarily-determined period synchronized with the audio data for the arbitrarily-determined period when the sound volume of the audio data for the arbitrarily-determined period is equal to or lower than the threshold, the first decoding processing being according to the compressed video data.

### CROSS-REFERENCE TO RELATED APPLICATION

This application is based upon and claims the benefit of priority from Japanese Patent Application No. 2009-213990, filed on Sep. 16, 2009; the entire contents of which are incorporated herein by reference.

### FIELD

Embodiments described herein relate generally to a video-audio playback apparatus.

### BACKGROUND

When a conventional video-audio playback apparatus is used to reproduce videos, the display output of smooth motion video is achieved by decoding the entire compressed video stream inputted into the video-audio playback apparatus.

However, this method must keep the video-decoding processor always running even for those videos that the viewers pay no attention or that the viewers are less likely to consider important, such as videos with few changes in their contents and videos with little motion, so that the processor has to be used frequently. In addition, the backlight used for the displaying apparatus such as a liquid-crystal display has to be always engaged while the apparatus is being used by a viewer, which brings about a problem of large electric-power consumption.

Some existing displaying apparatuses cut the electric-power consumption by turning off, or reducing the light of, the backlights of their liquid-crystal displays while playback contents without videos. However, this method is adopted only when the contents that the apparatuses are playback are those without videos.

### BRIEF DESCRIPTION OF THE DRAWINGS

FIG. 1 is a diagram illustrating the system configuration of a video-audio playback apparatus according to an embodiment.

FIG. 2 is a configuration diagram illustrating in detail the flow of data according to the embodiment.

FIG. 3 is an operational flowchart according to the embodiment.

FIG. 4 is a conceptual diagram of audio data according to the embodiment.

FIG. 5 is an operational flowchart according to the embodiment.

FIG. 6 is a conceptual diagram illustrating the relationship between the profile and the flag value in operational flow of the embodiment

FIG. 7 is an operational flowchart according to the embodiment.

FIG. 8 is an operational flowchart according to the embodiment.

FIG. 9 is a conceptual diagram illustrating the relationship among the profile, the flag value, the waveform of the output audio data, the luminance with which a liquid-crystal-panel backlight is lighted, the compressed video data, and the state of compressed-video-data decoding procedure, according to the embodiment.

### DETAILED DESCRIPTION

According to one embodiment, a video-audio playback apparatus including: a tuner configured to receive compressed video data and compressed audio data of a program; a compressed-audio-data decoding portion configured to decode the compressed audio data of the program sent from the tuner and thereby to generate audio data; an audio data processing portion configured to compare a sound volume of the audio data for an arbitrarily-determined period with a threshold; and a compressed-video-data decoding portion configured to perform first decoding processing on the compressed video data for the arbitrarily-determined period synchronized with the audio data for the arbitrarily-determined period when the sound volume of the audio data for the arbitrarily-determined period is equal to or lower than the threshold, the first decoding processing being according to the compressed video data.

An embodiment will be described below by referring to the drawings. Identical or equivalent portions that appear in various drawings are denoted by the same reference numerals and the description of those portions will not be repeated.

### Embodiment

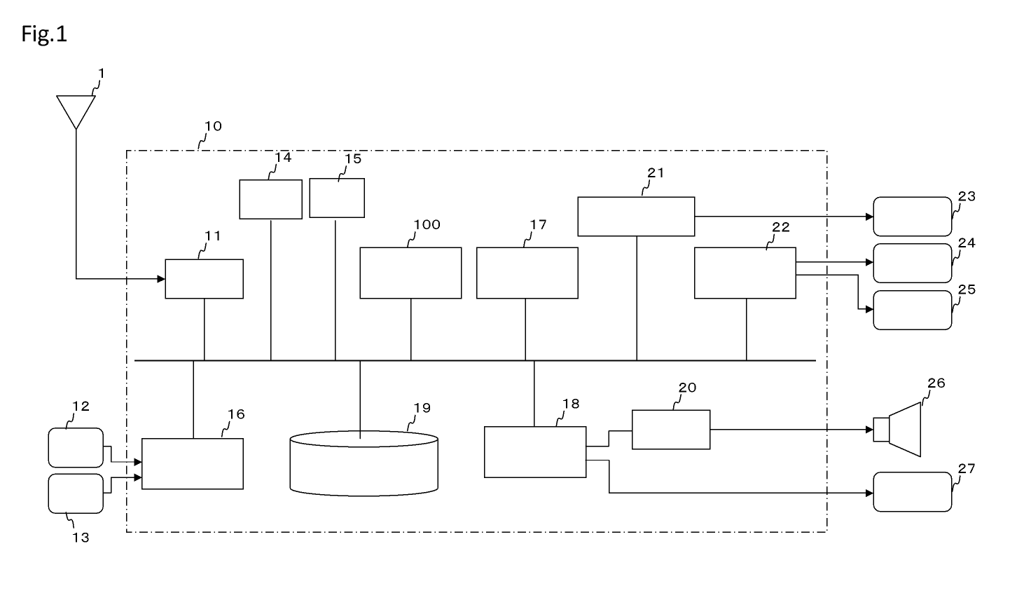

Firstly, the configuration of a video-audio playback apparatus 10 of an embodiment of the invention will be described by referring to FIG. 1.

The video-audio playback apparatus 10 of this embodiment includes: a tuner 11 configured to receive data of TV programs (streams of programs) via an antenna 1; an input-data processing processor 16 configured to receive, when necessary, inputs of compressed audio data and compressed video data from the tuner 11, a video-input terminal 12, and an audio-input terminal 13, and then to decode these compressed audio data and compressed video data; a remote-control signal receiver 14 configured to receive signals produced when the viewer operates the remote control to perform such operations as making the video-audio playback apparatus 10 start or stop playback; an operation portion 15 through which the viewer directly performs such operations as making the video-audio playback apparatus 10 start or stop the playback; a memory portion 19 configured to store video data and audio data to be outputted to a video-displaying liquid-crystal panel 24, a video-output terminal 25, a speaker 26, an audio-output terminal 27, and the like; a video-data processing processor 17 and an audio-data processing processor 18 configured to perform various kinds of processing, which will be described later, on the video data and on the audio data stored in the memory portion 19; a DAC-and-amplifier portion 20 configured to perform D/A conversion of, or to amplify, the audio data from the processing processor 18, and to output the resultant audio data to the speaker 26; a video-displaying-panel backlight controlling portion 21 configured to control the lighting state of a liquid-crystal-panel backlight 23; a video-displaying backend processing processor 22 configured to perform processing of filtering for image-quality improvement to enhance the image quality, or the like processing; and a controlling host processor 100 configured to control the above-mentioned processors, the video-displaying-panel backlight controlling portion 21, and the like.

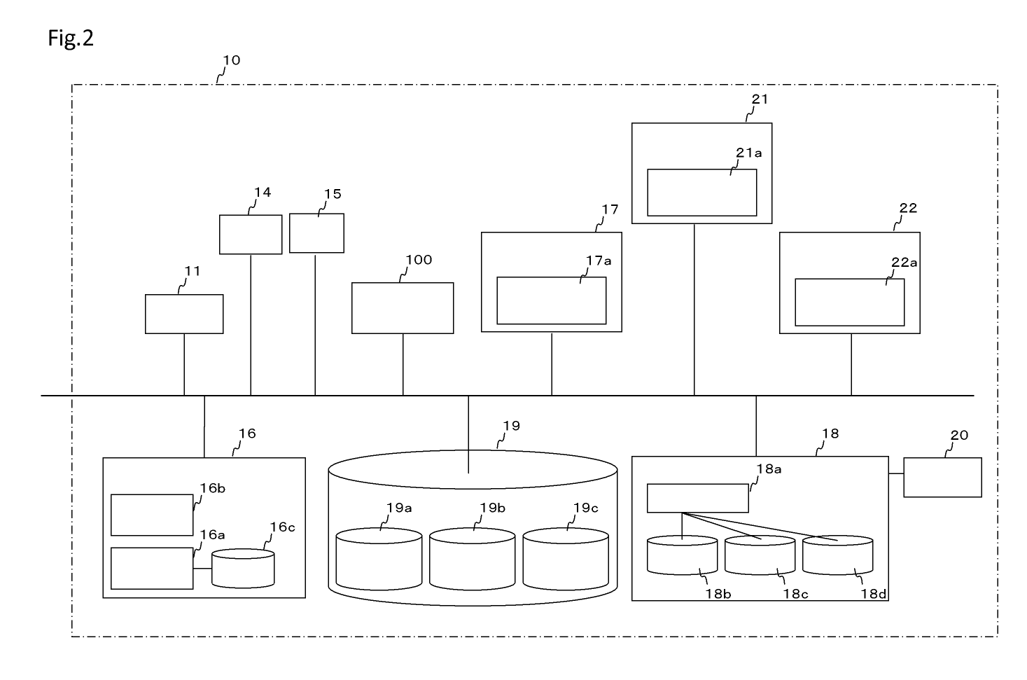

Subsequently, the configuration, the basic operations, and the flow of the data of this embodiment will be described by referring to FIG. 2.

The video-audio playback apparatus 10 is capable of receiving the input of compressed video data from either the antenna 1 or the video-input terminal 12, and of receiving the input of compressed audio data from either the antenna 1 or the audio-input terminal 13. The compressed video data and the compressed audio data thus inputted are then inputted into compressed-video decoding procedure 16a and compressed-audio decoding procedure 16b, respectively, of the input-data processing processor 16.

The compressed-video decoding procedure 16a generates video data through decoding processing, and then stores the video data in an output-video-data storing area 19a of the memory portion 19. In addition, the compressed-audio decoding procedure 16b generates audio data through decoding processing, and then stores the audio data in an output-audio-data storing area 19b of the memory portion 19.

The video data stored in the memory portion 19 are acquired by video-displaying backend processing procedure 22a of the video-displaying backend processing processor 22 so as to be subjected to various kinds of video processing which will be described later, and then are displayed on the video-displaying liquid-crystal panel 24.

In addition, the audio data stored in the memory portion 19 are acquired by audio-data processing procedure 18a of the audio processing processor 18 so as to be subjected to various kinds of audio processing which will be described later, and then are outputted as sound from the speaker 26 after being passed through the DAC/amplifier portion 20.

The compressed video data include I-Picture (Intra-Picture), P-Picture (Predictive-Picture), and B-Picture (Bi-directionally predictive-picture); and the data of any of the I-, P-, and B-Pictures are used for the video decoding. The I-Picture refers to the data which have no dependent relations with other frame images, and therefore complete frame images can be restored by decoding the data of I-Picture alone. The P-Picture refers to the data encoded with data-differential information predicted from foregoing frame-image data. The B-Picture refers to frame-image data coded with foregoing and succeeding references and data encoded with data-differential information predicted from both the frame received previously and the frame to be received. None of the P-Picture and the B-Picture can be decoded alone, so that no videos can be restored completely as expected from each of them only. To restore the video completely, it is necessary to start the decoding from the most immediate one of the foregoing I-Pictures.

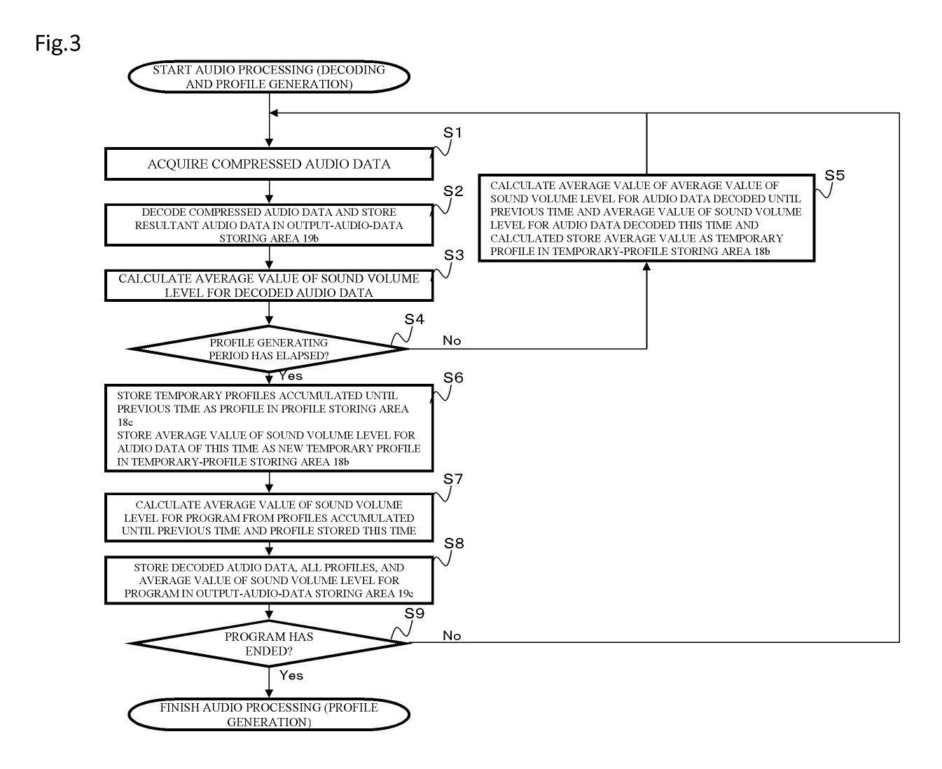

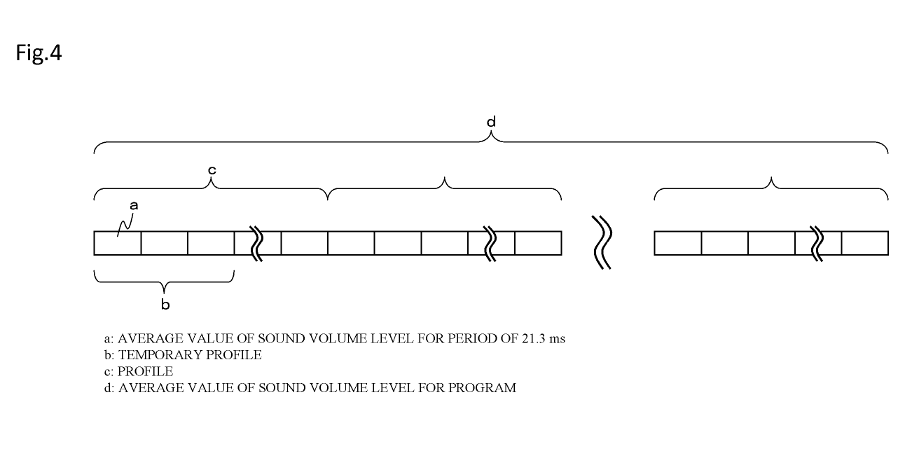

Subsequently, detailed operational flow of the audio processing (i.e., decoding and profile generation) of this embodiment will be described by referring to the diagram of the detailed system configuration shown in FIG. 2, the flowchart shown in FIG. 3, and the conceptual diagram of the audio data shown in FIG. 4.

Firstly at step S1, the compressed-audio-data decoding procedure 16b of the input-data processing processor 16 acquires compressed audio data from the tuner 11. The compressed audio data acquired here have a period of 21.3 ms, for example. Then at step S2, the compressed-audio-data decoding procedure 16b generates audio data by decoding the acquired compressed audio data, and stores the audio data in the output-audio-data storing area 19b. Then at step S3, the audio-data processing procedure 18a acquires the audio data from the output-audio-data storing area 19b, and calculates the average value of sound volume level thereof. Specifically, the audio-data processing procedure 18a calculates the average value of sound volume level for the audio data for a period of 21.3 ms, for example.

In this operational flow, by repeatedly calculating the average value of sound volume level for an arbitrarily-determined period of time (e.g., 5 seconds), a profile is generated for each of the arbitrarily-determined periods of time. Hereafter, the arbitrarily-determined period of time will be referred to as the profile generating period. In addition, in this embodiment, the compressed audio data are assumed to be received a profile generating period (e.g., 5 seconds) before the timing of outputting the sound and the video. Then, various kinds of processing, which will be described in detail below, are firstly performed on the compressed audio data, and then by taking the results into account, the controlling of the output of sounds and videos as well as the liquid-crystal-panel backlight 23 is performed.

Then at step S4, the audio-data processing procedure 18a determines whether the profile generating period has or has not elapsed. If a profile generating period has not elapsed yet, at step S5, the audio-data processing procedure 18a calculates an average value of the average value of the sound volume level for the audio data decoded this time and the average value for the audio data decoded before this time, and stores the average value thus calculated in a temporary-profile storing area 18b as a temporary profile. Here, if there are no audio data decoded previously, only the average value of the sound volume level for the audio data decoded this time is stored as a temporary profile in the temporary-profile storing area 18b. Then again at step S1, the next compressed audio data are acquired, and the subsequent steps S2 to S5 are repeated until the profile generating period has elapsed.

If the profile generating period has elapsed, the audio-data processing procedure 18a stores the temporary profiles accumulated until this time in the temporary-profile storing area 18b, that is, the temporary profiles for the profile generating period, in a profile storing area 18c as a collective profile at step S6. Then, the average value of sound volume level for the audio data acquired this time is stored as a new temporary profile in the temporary-profile storing area 18b.

Then at step S7, if there are any profiles accumulated until the previous time, the audio-data processing procedure 18a calculates the average value of sound volume level for the program by obtaining the average value of the profile stored this time and the profiles accumulated until the previous time. Then at step S8, the audio-data processing procedure 18a stores the average value of sound volume level for the program, the audio data, and the profile stored in the profile storing area 18c in an output-audio-data storing area 19c. These three kinds of information are updated incessantly while the program is being viewed.

If, for example, the profile generating period is five seconds, the profile and the average value of sound volume level for the program can be defined by the following Formulas 1 and 2. FIG. 4 shows a diagram of these concepts.

Profile=Average value of sound volume level for a period of 5 seconds=Σ{Average values of sound volume level for temporary profiles (e.g., for every 21.3 ms)}/Number of compressed audio frames contained in a period of 5 seconds (Formula 1)

Average value of sound volume level for the program=Average value of profiles accumulated since the start of receiving the program=Σ{Profiles accumulated since the start of receiving the program}/Number of profiles accumulated since the start of receiving the program (Formula 2)

Then at step S9, the controlling host processor 100 determines whether the program has or has not ended. If the program has already ended, the controlling host processor 100 makes the audio-data processing procedure 18a finish the audio processing (decoding and profile generation). If the program has not ended yet, the steps from step S1 are repeated until the program ends.

Note that the end of a program is recognized by, for example, making the controlling host processor 100 determine whether there is or is not a signal representing the end of the program, which is attached to the data of the program, such as the compressed video data or the compressed audio data.

Alternatively, the determination at step S9 may be done not only by recognizing the end of the program but also by the viewer's operation to stop the playback of the program by the video-audio playback apparatus 10. In this case, the signal of the viewer's operation to stop playback is inputted by either the remote-control signal receiver 14 or the operation portion 15 to notify the controlling host processor 100.

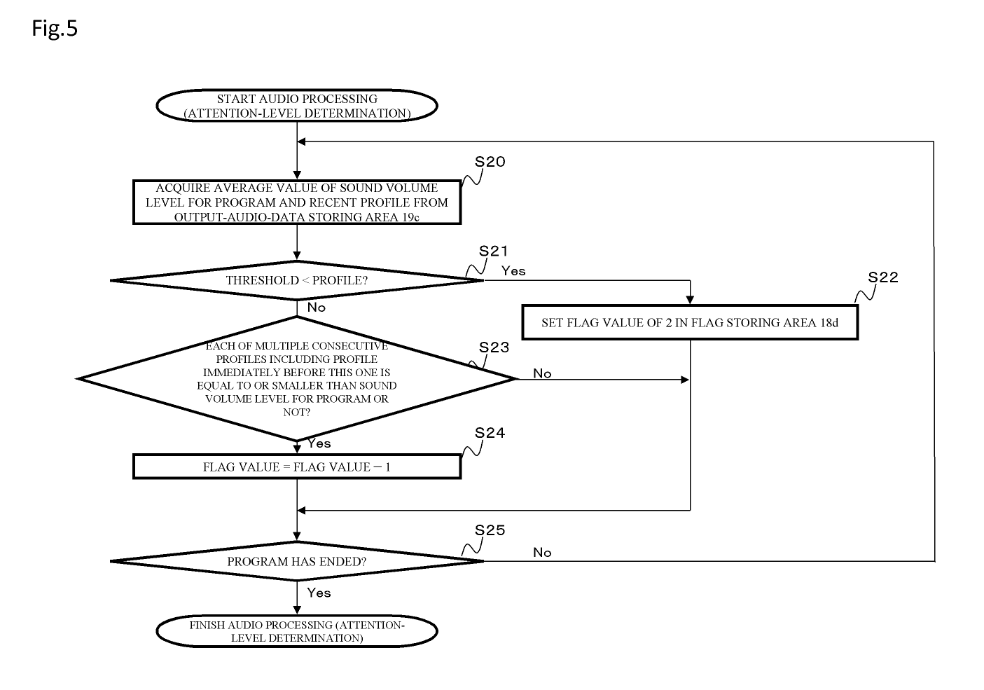

Subsequently, detailed operational flow of the processing to determine the attention level of the viewer will be described by referring to FIG. 5. The attention level is determined by checking the three kinds of information stored in the output-audio-data storing area 19c.

Firstly at step S20, the profile stored recently and the average value of sound volume level for the profiles accumulated since the start of receiving the program are acquired from the output-audio-data storing area 19c. The average value of sound volume level for the profiles accumulated since the start of receiving the program is used as a threshold.

Then at step S21, the threshold and the profile are compared with each other. If the profile is higher than the threshold, the flag value to determine the attention level (hereafter, simply referred to as the flag value) in a flag storing area 18d is set, for example, at 2 at step S22, and then at step S25, whether the program has or has not ended is determined. If the program has already ended, the audio processing (determination of attention level) is finished. If the program has not ended yet, the process at step S20 is performed again. Note that at the shipment of the video-audio playback apparatus from the factory, the recording flag and the playback flag do not have to be set.

If, on the other hand, the determination at step S21 concludes that the profile is equal to or lower than the threshold, it is determined at step S23 whether each of the consecutive multiple profiles (e.g., two; hereafter referred to as the consecutive number) including the profile immediately before this one is or is equal to or lower than the threshold. If each of these profiles is equal to or lower than the threshold, −1 is added to the flag value at step S24, and whether the program has or has not ended is determined at step S25. If the program has already ended, this audio processing (attention-level determination) is finished. If the program has not ended yet, the process at step S20 is performed again.

On the other hand, if each of the above-mentioned consecutive profiles is neither equal to nor lower than the threshold, no further arithmetic operation is performed on the flag value, and whether the program has or has not ended is determined at step S25. If the program has already ended, this audio processing (attention-level determination) is finished. If, on the other hand, the program has not ended yet, the process at step S20 is performed again.

The steps described above are repeated until the program ends.

Note that the value at which the flag value is set when the attention level is determined as being high is not necessarily 2. In addition, the value used in the arithmetic operation to be performed when the attention level is determined as being low is not necessarily −1. These values may be set appropriately. In addition, any value can be set as the initial value of the flag value.

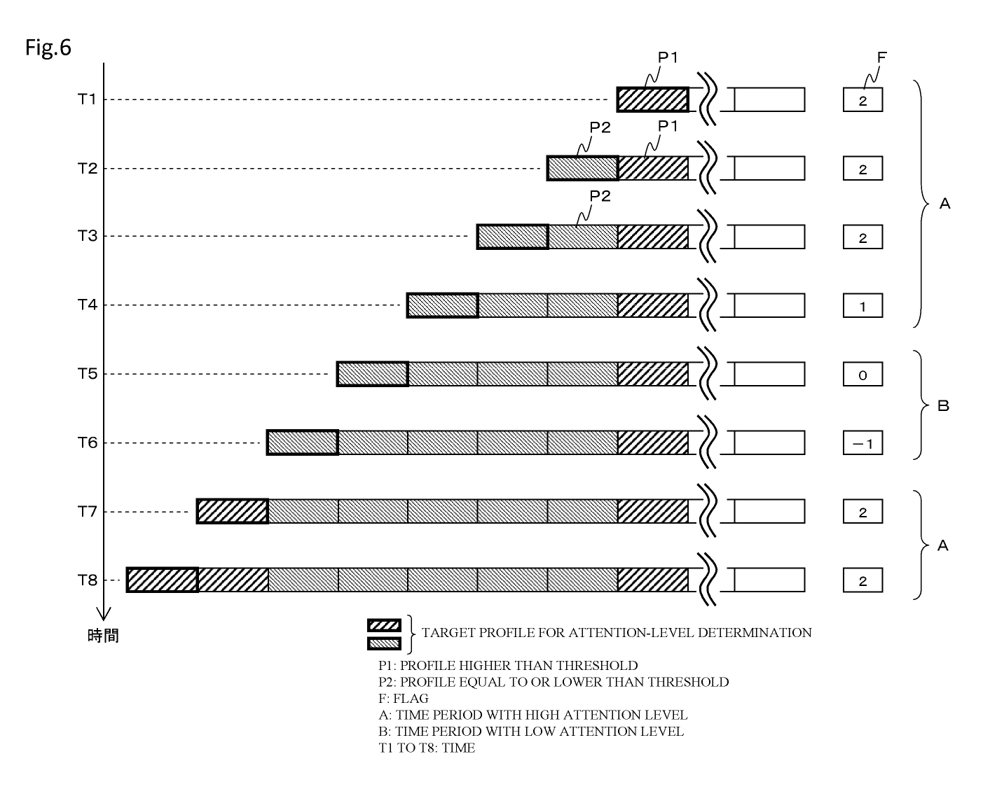

Subsequently, a conceptual diagram illustrating the relationship between the profiles of the above-described operational flow and the flag values is shown in FIG. 6. Note that, in FIG. 6, the consecutive number at step S23 is assumed to be two.

Firstly, since the target profile for the attention-level determination at a time T1 is a profile P1 that is higher than the threshold, the flag value is set at 2. Then, the target profile for the attention-level determination at a time T2 is a profile P2 that is lower than the threshold, but the profile immediately before the profile P2 is the profile P1, so that the flag value is kept at 2. In addition, the target profile for the attention-level determination at a time T3 is also a profile P2, but the profile preceding the one that is immediately before the profile P2 at the time T3 is the profile P1, so that the flag value is kept at 2.

Then, since the target profile for the attention-level determination at a time T4 is a profile P2, and both of the two consecutive profiles including the profile immediately before the one at the time T4 are profiles P2, −1 is added to the flag value. As a result, the flag value becomes 1. In addition, since the target profile for the attention-level determination at a time T5 is also a profile P2, −1 is again added to the flag value, so that the flag value becomes 0. The same applies to the case of a time T6, and therefore the flag value becomes −1.

Then, since the target profile for the attention-level determination at a time T7 is a profile P1, the flag value is set at 2. In addition, since the target profile for the attention-level determination at a time T8 is also a profile P1, the flag value is kept at 2.

Suppose, for example, that a time period with a flag value of 1 or larger is a time period with a high attention level. Having a flag value of 1 or larger, a time period from T1 to T4 and a time period from T7 to T8 have a high attention level. In contrast, having a flag value smaller than 1, a time period from T5 to T6 have a low attention level. Note that the flag value with which a time period is determined as having a high attention level is not necessarily 1 or higher. Rather, the flag value may be set appropriately.

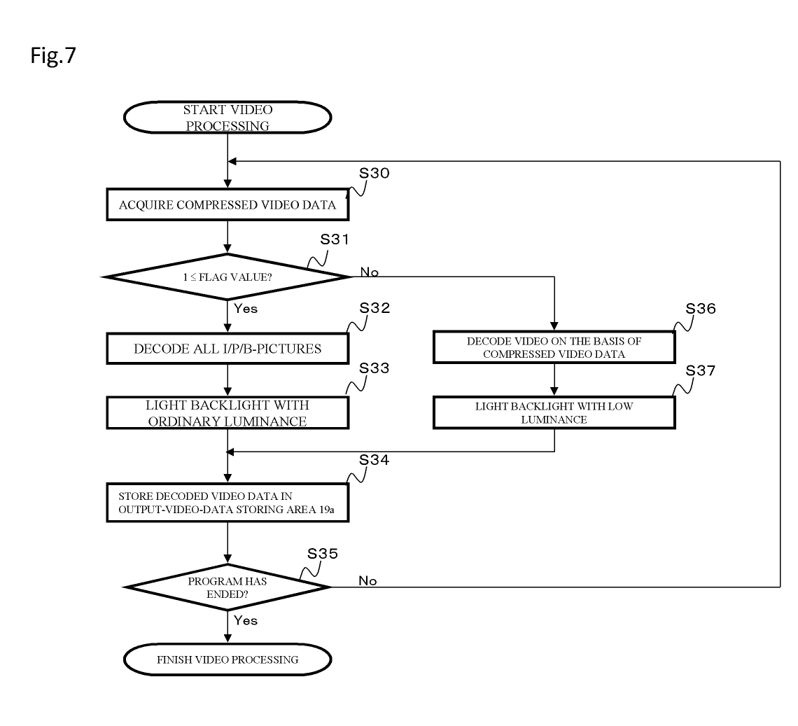

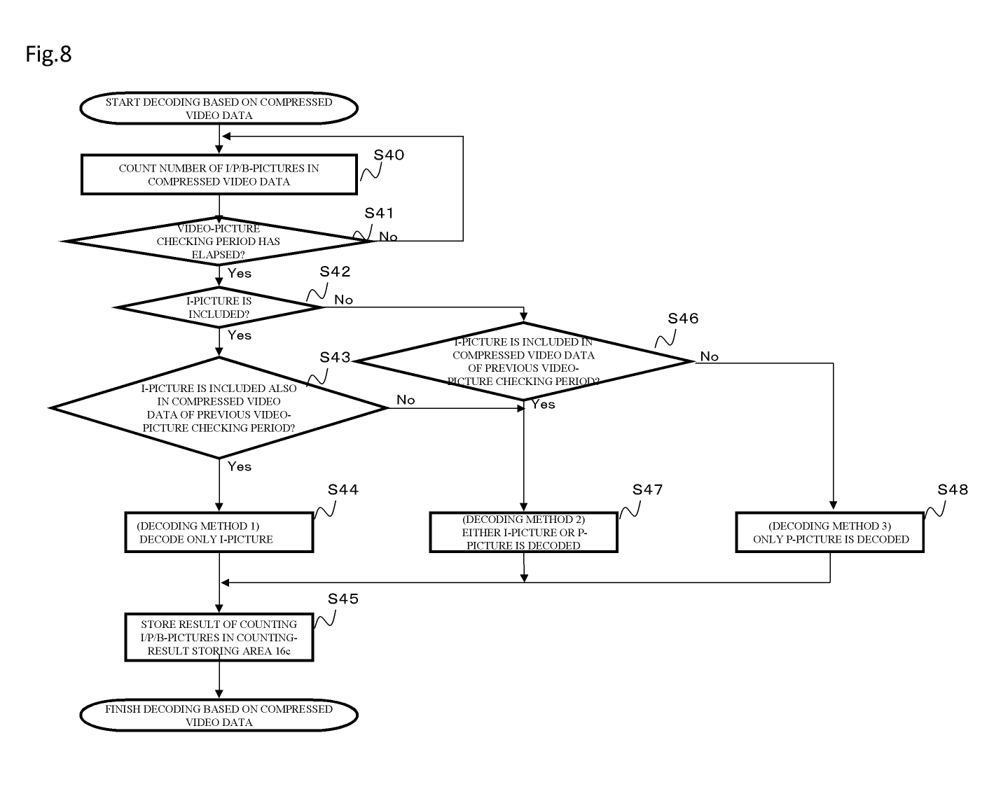

Subsequently, a detailed operational flow of video processing performed after a flag value is set in the above-described operation will be described by referring to FIGS. 7 and 8.

Firstly at step S30, the input-data processing processor 16 acquires compressed video data from the tuner 11 and passes the acquired compressed video data to the compressed-video-data decoding procedure 16a. Then at step S31, the controlling host processor 100 checks the flag value in the flag storing area 18d. If the flag value is one or larger, then at step S32, the controlling host processor 100 makes the compressed-video-data decoding procedure 16a decode all of the I/P/B-Pictures of the compressed video data acquired at step S30. Then at step S33, the controlling host processor 100 makes the video-displaying-panel backlight controlling portion 21 perform control so that the liquid-crystal-panel backlight 23 may be lighted with an ordinary luminance. The ordinary luminance mentioned above is from 450 to 550 cd/m² (candela per square meter).

Then at step S34, the compressed-video decoding procedure 16a stores the video data decoded at step S32 in the output-video-data storing area 19a. Then at step S35, the controlling host processor 100 determines whether the program has or has not ended. If the program has already ended, this video processing is finished. If the program has not ended yet, the process at step S30 is performed again where the input-data processing processor 16 acquires the next compressed video data.

On the other hand, if the flag value is neither equal to 1 nor larger than 1 at step S31, then at step S36, the controlling host processor 100 makes the compressed-video-data decoding procedure 16a decode the compressed video data acquired at step S30 in accordance with the decoding method based on the compressed video data. Details of the procedure for checking the decoding method based on the compressed video data will be described later by referring to FIG. 8. Then at step S37, the controlling host processor 100 makes video-displaying-panel backlight controlling portion 21 control the liquid-crystal-panel backlight 23 so that the liquid-crystal-panel backlight 23 can be lighted with a luminance that is lower than the ordinary one. Then, like the case described above, the decoded video data are stored at step S34, and then at step S35, whether the program has or has not ended is determined.

Subsequently, details of the procedure for checking the decoding method at step S36 mentioned above will be described by referring to FIG. 8.

Firstly, the compressed-video-data decoding procedure 16a counts, at step S40, how many I/P/B-Pictures of compressed video data have arrived, and then determines, at step S41, whether a video-picture checking period (e.g., 5 seconds) has or has not elapsed. The video-picture checking period mentioned here has the same length as the above-described profile generating period (e.g., 5 seconds), and the compressed video data of the video-picture checking period are data synchronized with the compressed audio data of the corresponding profile generating period.

If the determination at step S41 concludes that a video-picture checking period has elapsed, then at step S42, the compressed-video-data decoding procedure 16a determines whether I-Picture is or is not included in the compressed video data. If I-Picture is included, then at step S43, the compressed-video-data decoding procedure 16a determines whether I-Picture is or is not included in the compressed video data of a video-picture checking period that is immediately before the above-mentioned video-picture checking period (hereafter, referred to as the previous video-picture checking period). If I-Picture is included also in the compressed video data of the previous video-picture checking period, that is, I-Picture is included in the compressed video data of the two consecutive video-picture checking periods, then at step S44, the compressed-video-data decoding procedure 16a decodes only the I-Picture. This method will be referred to as the decoding method 1. Then at step S45, the compressed-video-data decoding procedure 16a stores, in a counting-result storing area 16c, the results of counting the I/P/B-Pictures in the video-picture checking period, and then the decoding based on the compressed video data is finished. Note that the counting-result storing area may be provided in the memory portion 19 instead.

If, on the other hand, the determination at step S42 concludes that no I-Picture is included, then at step S46, whether I-Picture is or is not included in the compressed video data of the previous video-picture checking period. If the determination at step 46 concludes that I-Picture is included, or if the determination at step S42 concludes that I-Picture is included but the determination at step S43 concludes that no I-Picture is included in the compressed video data of the previous video-picture checking period, that is, if I-Picture is not included in the compressed video data of both of the two consecutive video-picture checking periods, then at step S47, either I-Picture or the P-Picture is decoded. To put it differently, if I-Picture is included, the I-Picture is decoded, but if no I-Picture is included, P-Picture is decoded instead. This will be referred to as the decoding method 2. Then at step S45, as in the above-described case, the results of counting the I/P/B-Pictures in the video-picture checking period is stored in the counting-result storing area 16c, and then the decoding based on the compressed video data is finished.

If the determination at step S46 concludes that no I-Picture is included in the compressed video data of the previous video-picture checking period, only the P-Picture is decoded at step S47. This will be referred to as the decoding method 3. Then at step S45, as in the above-described case, the results of counting the I/P/B-Pictures in the video-picture checking period is stored in the counting-result storing area 16c, and then the decoding based on the compressed video data is finished.

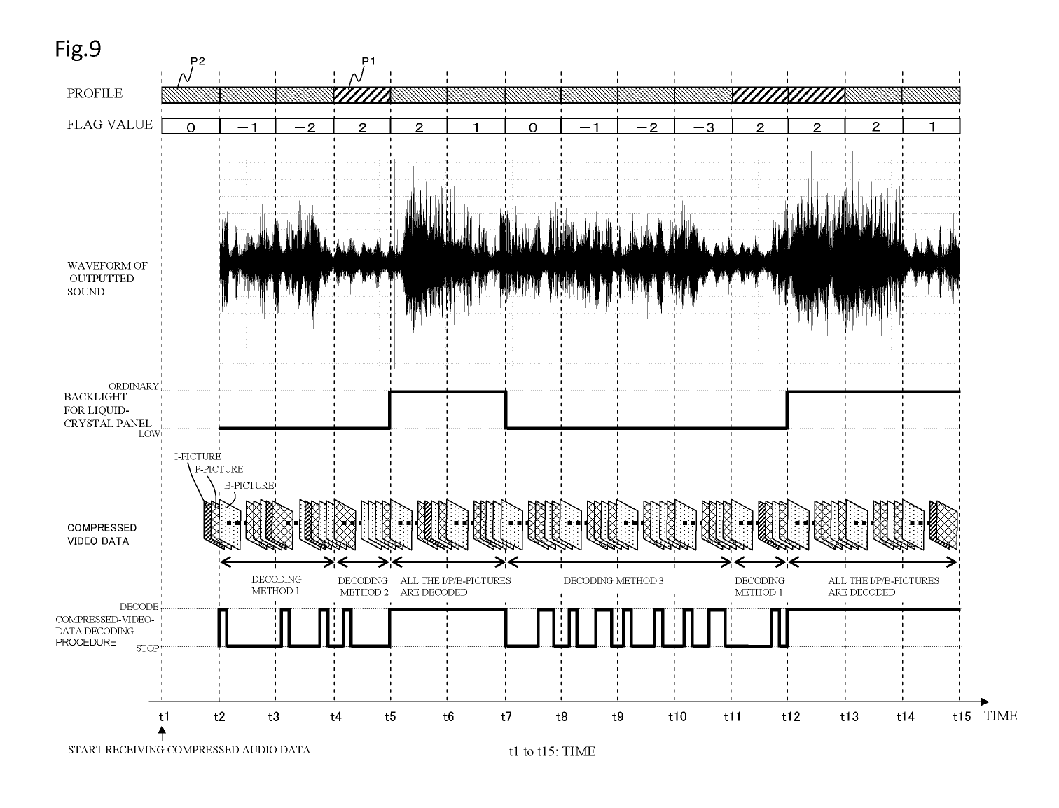

Subsequently, FIG. 9 shows the relationship among the profile, the flag value, the waveform of outputted audio data, the luminance of lighting liquid-crystal-panel backlight 23, the compressed video data, and the state of the compressed-video-data decoding procedure 16a. In FIG. 9, the initial value of the flag value is assumed to be zero.

Since, as has been described earlier, the compressed audio data are received a profile generating period (e.g., 5 seconds) before the timing at which the sound and the video are outputted, the receiving of the compressed audio data starts at a time t1 and the generation of a profile also starts at the time t1.

Since the profiles for a period from the time t1 to a time t2, a period from the time t2 to a time t3, and a period from the time t3 to a time t4 are profiles P2, their corresponding flag values, whose initial value is zero, are 0, −1, and −2, respectively. Note that the consecutive number at step S23 of FIG. 5 is assumed to be one.

Then, on the basis of these flag values, the luminance of the liquid-crystal-panel backlight 23 is lowered in the periods from the time t2 to the time t3, from the time t3 to the time t4, and from the time t4 to the time t5.

Of all these periods, I-Picture is included in the compressed video data of the period from the time t2 to the time t3 and the period from the time t3 to the time t4. The compressed video data of the period from the time t2 to the time t4 are decoded by the decoding method 1. Specifically, since the compressed video data of the period from the time t2 to the time t3 includes a single I-Picture, the single I-Picture is decoded. In addition, since the compressed video data of the period from the time t3 to the time t4 includes two I-Pictures, the two I-Pictures are decoded. Since the compressed video data of the period from the time t4 to the time t5 includes no I-Picture, and the compressed video data of the period from the time t3 to the time t4 includes I-Pictures, the compressed video data of the period from the time t4 to the time t5 are decoded by the decoding method 2. Specifically, since the compressed video data of the period from the time t4 to the time t5 includes a single P-Picture, the single P-Picture is decoded.

Then, since the profile for the period from the time t4 to a time t5 is a profile P1, the corresponding flag value is 2. Then, although the profile for the period from the time t5 to a time t6 is a profile P2, the flag value for the period from the time t5 to the time t6 is kept at 2 since the profile for the period from the time t4 to the time t5 is a profile P1. Then, since the profile for the subsequent period from the time t6 to a time t7 is a profile P2, and the consecutive number at step S23 of FIG. 5 is one, the flag value for the period from the time t6 to the time t7 is 1.

Then, on the basis of these flag values, the luminance of the liquid-crystal-panel backlight 23 is set at the ordinary luminance both in the period from the time t5 to the time t6 and in the period from the time t6 to the time t7, and is lowered in the period from the time t7 to a time t8.

Since the flag value is 1 for the period from the time t5 to the time t6 and for the period from the time t6 to the time t7, all the I/P/B-Pictures of the compressed video data of these periods are decoded. Since the flag value for the period from the time t7 to the time t8 is smaller than 1, and neither the compressed video data of the period from the time t7 to the time t8 nor the compressed video data of the previous period from the time t6 to the time t7 include any I-Picture, the compressed video data of the period from the time t7 to the time t8 are decoded by the decoding method 3. Specifically, the compressed video data of the period from the time t7 to the time t8 include two P-Pictures, the two P-Pictures are decoded. From then on, similar processing is successively performed until a time t15.

According to this embodiment, it is possible to provide a video-audio playback apparatus capable of reducing the electric-power consumption by controlling the video decoding and the liquid-crystal-panel backlight if the viewer's attention level, which is determined on the basis of the sound volume level, is determined as being low, that is, if the sound volume level is low. In contrast, if the viewer's attention level is determined as being high, the video and the sound are outputted completely as expected and, simultaneously, the liquid-crystal-panel backlight is controlled so as to restore the ordinary luminance. In addition, since the flag value is calculated by considering the states of the multiple profiles including the profile immediately before the target profile for the sound volume-level determination, the state of the period when the viewer's attention level is determined as being high can be kept for a while even after the profile drops down below the average sound volume level of the program. Accordingly, the viewer is less likely to miss the scene which comes immediately after the scene with a high attention level and which might still be important to the viewer.

Note that the embodiment described above is not the only form of carrying out the invention.

For example, to enhance the image quality, the video-displaying backend processing procedure 22a of the video-displaying backend processing processor 22 may stop the image-quality improving filtering processing or the like if the flag value is, for example, smaller than 1, and may perform the image-quality improving filtering processing only when the flag value is, for example, equal to or larger than 1. Thereby, the processing to enhance the image quality does not have to be performed all the time, allowing the electric-power consumption to be cut furthermore.

In addition, instead of making the compressed-video-data decoding procedure 16a change the target picture for the decoding as in the case of the above-described embodiment, the electric-power consumption of the video-data processing processor can be cut by slowing down the system clock speed of the video-data processing processor and/or by thinning out the compressed video data if the flag value is, for example, smaller than 1.

In addition, the video-displaying liquid-crystal panel 24 is not the only possible kind of displaying device. A plasma display apparatus or other kinds of displaying device may be used instead. If the displaying device needs no backlight, neither the video-displaying-panel backlight controlling portion 21 nor the liquid-crystal-panel backlight 23 are necessary.

In addition, the video-audio playback apparatus 10 shown in FIG. 1 includes none of the antenna 1, the audio-input terminal 13, the video-input terminal 12, the operation portion 15, the liquid-crystal-panel backlight 23, the video-displaying liquid-crystal panel 24, the video-output terminal 25, the speaker 26, and the audio-output terminal 27, but such a configuration is not the only possible example. Some, or all, of these may be included in the configuration of the video-audio playback apparatus 10, if necessary.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A video-audio playback apparatus comprising:
a compressed-audio-data decoder configured to decode compressed audio data of a program to generate audio data;
an audio data processor configured to compare a sound volume of the audio data for a period to a threshold; and
a compressed-video-data decoder configured to execute first decoding processing on compressed video data for the period synchronized with the audio data for the period when the sound volume of the audio data for the period is equal to or lower than the threshold, the first decoding processing being according to the compressed video data.

2. The video-audio playback apparatus of claim 1, wherein when the sound volume of the audio data for the period is higher than the threshold, the compressed-video-data decoder is configured to execute second decoding processing on the compressed video data for the period synchronized with the audio data for the period.

3. The video-audio playback apparatus of claim 1, wherein the threshold is an average value of sound volumes of sets of audio data for a plurality of the periods since reception of the program is started.

4. The video-audio playback apparatus of claim 2, wherein the threshold is an average value of sound volumes of sets of audio data for a plurality of the periods since reception of the program is started.

5. The video-audio playback apparatus of claim 1, wherein, in the first decoding processing, any of a first decoding method by which only Intra (I)-Picture coded without reference to other pictures is decoded, a second decoding method by which either I-Picture or Predictive (P)-Picture coded with reference to a previous I-Picture or P-Picture is decoded, and a third decoding method by which only P-Picture is decoded is selectively adopted for the compressed video data for the period.

6. The video-audio playback apparatus of claim 4, wherein, in the first decoding processing, any of a first decoding method by which only I-Picture is decoded, a second decoding method by which either I-Picture or P-Picture is decoded, and a third decoding method by which only P-Picture is decoded is selectively adopted for the compressed video data for the period.

7. The video-audio playback apparatus of claim 2, wherein, in the second decoding processing, all of the I-Pictures, the P-Pictures, and Bidirectional-predictive (B)-Pictures coded with reference to one or more previous and following pictures in the compressed video data for the period are decoded.

8. The video-audio playback apparatus of claim 1, wherein the compressed-video-data decoder is configured to perform the first decoding processing on the compressed video data for the period synchronized with the audio data for the period, if the sound volume of the audio data for the period is equal to or lower than the threshold, and if either a sound volume of preceding audio data for the period immediately before the audio data for the period, or a sound volume of each set of audio data for a plurality of consecutive periods having the sound volume of the preceding audio data for the period immediately before the audio data for the period, is equal to or lower than the threshold.

9. The video-audio playback apparatus of claim 1, further comprising a video-displaying-panel backlight controller configured to switch a luminance of a liquid-crystal-panel backlight to a lower luminance than an ordinary luminance if the sound volume of the audio data for the period is equal to or lower than the threshold.

10. The video-audio playback apparatus of claim 1, further comprising a controlling host configured to control a tuner, the compressed-audio-data decoder, the audio data processor, the compressed-video-data decoder, and a video-displaying-panel backlight controller.

11. A video-audio playback apparatus comprising:
a compressed-audio-data decoder configured to decode compressed audio data of a program to generate audio data;
an audio data processor configured to compare a sound volume of the audio data for a period to a threshold; and
a compressed-video-data decoder configured to execute first decoding processing on compressed video data for the period synchronized with the audio data for the period when the sound volume of the audio data for the period is equal to or lower than the threshold, the first decoding being according to the compressed video data, wherein
when the sound volume of the audio data for the period is higher than the threshold, the compressed-video-data decoder is configured to execute second decoding processing on the compressed video data for the period synchronized with the audio data for the period,
the threshold is an average value of sound volumes of sets of audio data for a plurality of the periods since reception of the program is started,
in the first decoding processing, any of a first decoding method by which only I-Picture is decoded, a second decoding method by which either I-Picture or P-Picture is decoded, and a third decoding method by which only P-Picture is decoded is selectively adopted for the compressed video data for the period,
in the second decoding processing, all of the I-Picture, the P-Picture, and B-Picture included in the compressed video data for the period are decoded,
the compressed-video-data decoder is configured to execute the first decoding processing on the compressed video data for the period synchronized with the audio data for the period if the sound volume of the audio data for the period is equal to or lower than the threshold, and if either a sound volume of preceding audio data for the period immediately before the audio data for the period or a sound volume of each set of audio data for a plurality of consecutive periods having the sound volume of the preceding audio data for the period immediately before the audio data for the period is equal to or lower than the threshold,
wherein the video-audio playback apparatus further comprises:
a video-displaying-panel backlight controller configured to switch a luminance of a liquid-crystal-panel backlight to a lower luminance than an ordinary luminance if the sound volume of the audio data for the period is equal to or lower than the threshold;
a controlling host configured to control a tuner, the compressed-audio-data decoder, the audio data processor, the compressed-video-data decoder, and the video-displaying-panel backlight controller.
